(19) United States
(12) Patent Application Publication
(10) Pub. No.: US 2017/0213220 A1
(43) Pub. Date: Jul. 27, 2017

(54) SECURING TRANSACTIONS ON AN INSECURE NETWORK

(71) Applicant: Sigue Corporation, Sylmar, CA (US)

(72) Inventor: Max Stanford Tomlinson, JR., Stevenson Ranch, CA (US)

(21) Appl. No.: 15/005,759

(22) Filed: Jan. 25, 2016

(51) Int. Cl. G06Q 20/40; H04L 29/06

(52) U.S. Cl. CPC G06Q 20/4014; H04L 67/42; H04L 63/0428; H04L 63/083; H04L 63/102

(57) ABSTRACT

Systems and methods are provided for enhancing the security of a multi-network computing environment in which at least one of the networks is not secure and at least one of the communicating devices does not send secure messages. An authorization service may maintain two authentication codes that are associated with a client or a computing device. The client or a transaction request system may initiate communication via a secured network, and may securely transmit a client identifier and a first authentication code to an authorization service. The client, using an unsecured mobile device, may then transmit a second authentication code, via the insecure network, to the authorization service to authenticate the unsecured device and confirm the communication.

### BACKGROUND

Providers of commercial goods and services, herein generally referred to as “vendors,” may utilize communication networks to exchange data. Specifically, vendors may utilize communication networks to conduct transactions with clients. In turn, clients may utilize communication networks to initiate payment for goods and services, using smartphones or other computing devices to communicate via the networks. Clients may initiate payment, for example, by communicating with a financial institution or other service to authorize a payment to a vendor account.

Communication networks may be secured by, for example, allowing communications only from authorized senders, encrypting communications, authenticating users (e.g., requiring a login and password), providing for verification of message contents (e.g., providing a checksum or a public key), or by various combinations of these approaches. Operators of communication networks may implement security measures at the network level, such as by implementing a secure network protocol or a private network. However, some communication networks may be insecure, either by design or due to ineffective security measures.

Parties that communicate via an insecure network may themselves implement measures, including some of the measures described above, to provide security for individual transactions. However, some parties to a transaction may be unable to implement secure communication. For example, a client computing device may lack the software or processing power required to implement an encryption protocol, or the parties may have a “chicken-and-egg” problem, in which the information needed to establish a secure connection cannot be communicated securely. Additionally, some networks, such as radio networks, may be inherently vulnerable to eavesdropping or interception of messages.

### BRIEF DESCRIPTION OF THE DRAWINGS

The foregoing aspects and many of the attendant advantages will become more readily appreciated as the same become better understood by reference to the following detailed description, when taken in conjunction with the following drawings, wherein:

FIG. 1 is a simplified block diagram illustrating an authorization service securing and processing a transaction between a customer and a vendor.

FIG. 2 depicts an illustrative operating environment in which an authorization service communicates with a vendor and a client computing device via one or more networks.

FIG. 3 is a block diagram illustrating an authorization service securing a transaction within the operating environment of FIG. 2.

FIG. 4 depicts a general architecture of an example computing system for providing an authorization service.

FIG. 5 is a flow diagram of an illustrative method implemented by an authorization service for authorizing a financial transaction.

FIG. 6 depicts an example authentication request displayed on a client computing device, which may be generated by an authorization service.

These and other features will be described herein with reference to the drawings summarized above. The drawings and the associated descriptions are provided to illustrate certain embodiments and not to limit the scope of the invention.

### DETAILED DESCRIPTION

Aspects of the present disclosure relate to verifying transactions conducted at least in part via an insecure network. More specifically, aspects of the present disclosure include systems and methods for an authorization service, which provides enhanced security when a party to a financial transaction uses an insecure device to communicate via an insecure network. Generally defined, an insecure network is one where an untrusted third party may be capable of intercepting, monitoring, or impersonating communications from a legitimate party to the transaction. For example, a computing device may use one of the IEEE 802.11 “Wi-Fi” standards to transmit and receive information wirelessly. These wireless communications may be received by parties other than the intended recipient and, if not encrypted or otherwise secured, an unauthorized third party may be able to monitor them. As further examples, a third party may operate a network or network node for the purpose of intercepting communications (e.g., “evil twin” networks or StingRay devices), or may otherwise conduct man-in-the-middle attacks or eavesdrop on communications. An insecure device is generally defined as a device that cannot or does not implement security measures at the individual message level, such as encrypting the message or providing a public key to allow verification of the message, when communicating via an insecure network. For example, a feature phone, wearable computing device, or other computing device with limited resources may lack necessary software or computing power to transmit individual messages securely.

A message from one computing device to another may pass through multiple networks in a single session. An unsecured message may thus be compromised if it passes through a single insecure network, even if all of the other networks involved in communicating the message are secured against unauthorized third parties. Aspects of the present disclosure provide enhanced security in such instances, in some embodiments without requiring that the message be encrypted or otherwise secured before being sent via the insecure network.

Communications via an insecure network may be secured independently of the network itself. For example, the parties communicating via an insecure network may agree to encrypt messages using an encryption protocol, which prevents unauthorized third parties from eavesdropping. However, the parties may be unable to agree on an encryption protocol over the insecure network without providing the third party with the information it needs to identify the protocol and decrypt the messages. Aspects of the present disclosure allow computing devices to communicate with enhanced security despite these obstacles.

In some embodiments, the enhanced security for an overall transaction authorization described herein may be provided even when unsecured messages are intercepted or when a computing device is successfully impersonated by a third party. For example, according to some embodiments, an authorization server must receive two authentication codes (referred to herein as a shared code and a private code) to verify a transaction request. However, only one of the authentication codes is transmitted insecurely, and thus a third party who intercepts the insecure messages does not receive all of the information needed to impersonate the legitimate party to the transaction.

In one embodiment, an authorization service that includes one or more computing devices may receive, within a secure transmission, a transaction request from a vendor computing system. The vendor computing system may illustratively be operated by a vendor that engages in financial transactions with customers. However, the vendor may be unable to verify the identity of a potential customer, and accordingly may transmit the request to the authorization service to verify the customer and process the transaction.

Illustratively, the transaction request sent or forwarded to the authorization service may include a client identifier and a first authentication code. In some embodiments, the authorization service may determine the client identifier and the first authentication code by processing the electronic message. For example, the authorization service may decrypt an encrypted message and extract data from specific fields to determine that the message contains a client identifier and authentication code. In other embodiments, the client identifier and the first authentication code may be provided directly.

The authorization service may determine that the transaction request corresponds to a given client account at least in part by matching the client identifier associated with the message with a first client identifier previously stored in an electronic data store, such as a data store that includes account information for a potentially large number of different clients of the authorization service. The authorization service may validate the first code at least in part by determining that the first code within the message matches a shared code associated with the client account in the electronic data store. Upon validation of the first code, the authorization service may generate a client authentication request, which may include both information regarding the transaction request and a request for transaction authorization.

Having generated the client authentication request, the authorization service may send the client authentication request to an unsecured client computing device (such as a mobile phone or other communications device) that is associated with the first account based on information stored in the electronic data store. For example, the authorization service may identify, based on the electronic data store, that a mobile phone or other computing device associated with the first account is configured to receive unsecured messages via an unsecured network, such as by receiving unencrypted Short Message Service (SMS) messages via a cellular network. The authorization service may thus send the unsecured client authentication request via the unsecured network. When a responsive message is received by the authorization service from the same computing device, the authorization service may validate the responsive message by confirming that at least a portion of content within the responsive message matches a previously stored private code associated with the first account in the electronic data store. If the responsive message is successfully validated, the authorization service may process the transaction and send an approval indication to the vendor computing device. If validation fails, the authorization service may instead send a denial indication to the vendor computing device.

In some embodiments, the shared code and the private code may have distinct characteristics that reduce the likelihood of confusing one code for the other. For example, the shared code may be a series of numbers and the private code may be a series of letters. As a further example, the shared code or the private code may have a distinct prefix or suffix, checksum digits, or other characteristics that support distinguishing the codes. In further embodiments, the vendor computing system or the client computing device may prevent the other code from being entered, or may recognize that the wrong code type (e.g., private code instead of shared code) has been entered and take corrective action. For example, the vendor computing system may only allow numeric input when a shared code is being entered, such as by an application executed on a vendor computing system displaying only number keys on a touchscreen-displayed virtual keyboard when prompting for entry of a shared code. As a further example, the client computing device may determine that a shared code has been input instead of a private code, and may display a message requesting the private code rather than transmitting the shared code insecurely.

To further enhance security, in some embodiments, the authorization service may verify that a client authorizing the request is in a particular physical location. Illustratively, the authorization service may transmit instructions to the unsecured computing device that direct the client to interact with a verification device, which may be physically co-located with the vendor. The verification device may be equipped with an input device, such as a button, numeric keypad, keyboard, touchscreen, or pointing device. The verification device may be further equipped with, for example, Global Positioning System (GPS) capability, and may store a unique verification key, such as a public encryption key. In an embodiment, the verification device may communicate with the authorization service via a different network or networks than the vendor uses to communicate with the authorization service. The authorization service may illustratively require that the response to the client authentication request be transmitted via the verification device, or may require a message from the verification device in addition to the response. The message from the verification device may illustratively include a current GPS location, and may be signed using the verification device's public key. In other embodiments, the vendor's system may include a camera that captures an image of the client's face, which may be sent to the authorization service for automated face detection using previously captured images of the client.

In some embodiments, the authorization service may send an indication that causes the vendor, a financial institution, or another party to process the transaction, rather than the authorization service processing the transaction itself. For example, the authorization service may receive and process requests from a financial institution to verify the identity of a purported client, and may respond to such requests to indicate that it confirms (or does not confirm) the identity of the client. In these embodiments, the authorization service may only store and maintain information as required to verify client identity, and may omit storage of account balances or other information used to process transaction requests.

In alternative embodiments, the authorization service may communicate with the purported source of a transaction request via an interactive voice response (IVR) system. For example, the authorization service may identify a telephone number associated with the client account, and may send the client authentication request by calling the telephone number and providing voice output. The authorization service may then obtain a response to the client authentication request, including an authentication code, via voice or touch-tone responses to interactive prompts.

In further embodiments, the authorization service may process requests from vendors to automatically identify a specific client based on identifying a computing device associated with the client. For example, the authorization service may receive a request from a vendor computing device that includes a device identifier, such as a MAC address, serial number, telephone number, IP or network address, or other type of “fingerprint” based on characteristics or activities associated with the device. Illustratively, the vendor may operate a passive monitoring device, which constantly “listens” or scans a network to identify that a computing device with a particular identifier has accessed or is within range of the network. The vendor may then query the authorization service to obtain account information, transaction history, or other identifying information. The vendor may then use this information for a variety of purposes, such as to pre-populate forms with default information values or provide customized services to the client.

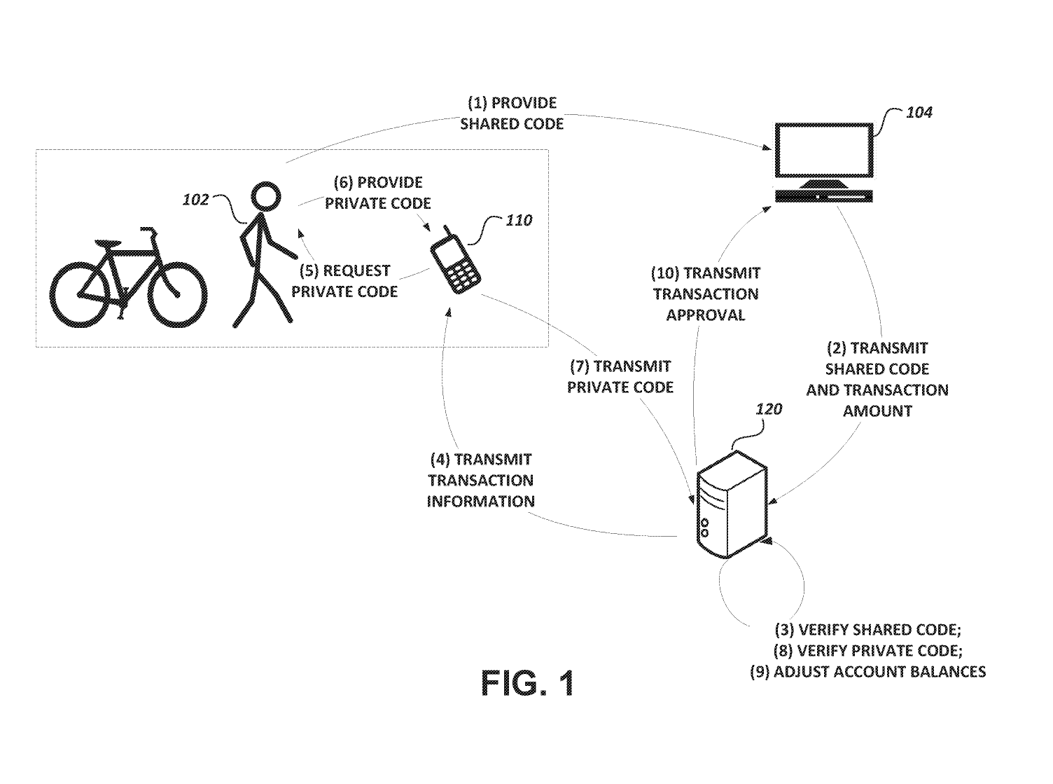

FIG. 1 depicts a simplified block diagram of an authorization service 120 authenticating and processing a transaction request. In the illustrated embodiment, the flow begins with a consumer 102, who wishes to purchase a product (in this example, a bicycle) from a vendor (who may be the operator of a vendor computing device 104). The consumer may be physically present in a retail store of the vendor, for example, such as standing at a checkout counter and interacting with a store clerk. At (1), the consumer 102 may provide a shared code to the operator of the vendor computing device 104, such as a store clerk or cashier, who may in turn enter the shared code and other transaction information into an electronic form or other user interface presented by the vendor computing device 104. In other embodiments, the consumer 102 may input the shared code on an input device, such as a keypad or touchscreen, that is associated with the vendor computing device 104, such that no vendor employee or human operator other than the consumer himself is needed. At (2), the vendor computing device 104 transmits a transaction request, including the shared code and the amount of the transaction (potentially including other information that will be discussed below), to an authorization server 120 via a secure network connection or otherwise in a secure manner. For example, the transaction request may be encrypted, or in various embodiments other security measures as described above may be employed to secure the transaction request.

At (3), as described in more detail below, the authorization server 120 verifies the shared code. In some embodiments the authorization server 120 may further verify the identity of the vendor, based on, for example, a provided vendor ID and/or vendor authentication code, or based on characteristics of the vendor computing device 104. At (4), having verified the shared code, the authorization server 120 identifies a client computing device 110 associated with the client shared code (such as by identifying a phone number stored in association with the client's account, an IP address of a computing device, or a device identifier sufficient to send a push notification to the device), and transmits an authorization request to the client computing device 110. As described below, the authorization request may be transmitted over an unsecured network, and may include a request for the consumer 102 to provide a private authentication code to verify the consumer's identity and the consumer's approval of the transaction.

At (5), the client computing device 110 presents the authorization request to the consumer 102, who at (6) provides the private code. At (7), the client computing device 110 transmits the private code to the authorization server, illustratively using the same unsecured network used at (4). At (8), as described below, the authorization server 120 verifies the private code, and at (9) the authorization server 120 may process the transaction. As described in more detail below, the authorization server 120 may process the transaction, for example, by debiting an account associated with the consumer 102 and crediting an account associated with the vendor by a transaction amount that was provided with the original transaction request from the vendor computing device 104. At (10), the authorization server transmits a response to the transaction request at (2), indicating to the vendor computing device 104 that the transaction request was approved and processed.

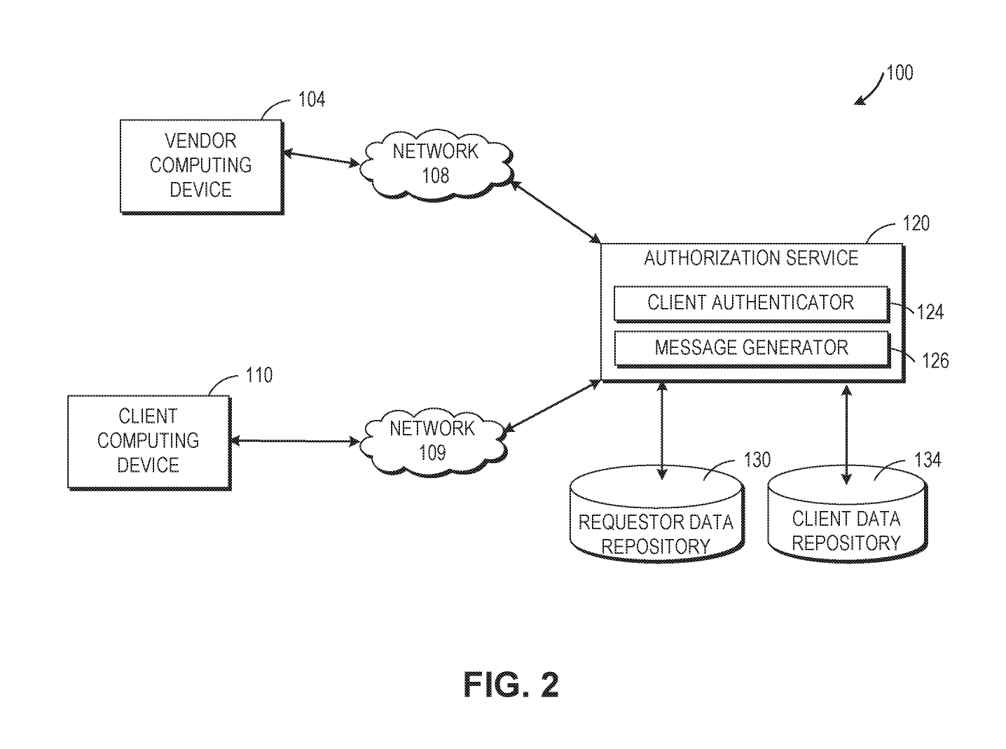

FIG. 2 depicts an illustrative operating environment 100 in which the authorization service 120 communicates with a vendor computing device 104 and a client device 110 via one or more networks 108 and 109. Depending on the embodiment, the authorization service 120 may be represented in a single physical server or single computing device or, alternatively, may be split into multiple physical servers or other computing devices. While a single vendor computing device 104 and a single client device 110 are illustrated in FIG. 2 for ease of description, it will be appreciated that the authorization service 120 may be configured to process requests that may originate from any of a potentially large number of different vendor computing devices located in various geographic locations, and may be configured to authenticate communications associated with any of a large number of different clients and associated client devices.

The authorization service 120 may include a client authenticator 124 and a message generator 126 stored in memory therein that may be used to implement various aspects of the present disclosure, as will be further described below. In some embodiments, the client authenticator 124 and message generator 126 may each be stored as computer-executable instructions, while in other embodiments one or both of the client authenticator and/or message generator may be integrated within specialized hardware. Those skilled in the art will recognize that the client computing device 110 and the vendor computing device 104 may each be any of a number of computing devices that are capable of communicating over a network. For example, the vendor computing device 104 may include, but is not limited to, a laptop, desktop personal computer, tablet computer, point-of-sale (POS) system or terminal, mobile phone, smartphone, wearable computing device, gaming console, kiosk, augmented reality device, other wireless device, set-top or other television box, or other system. The client computing device 110 may be any computing device capable of being configured to receive messages that the authorization service 120 is configured to send in a given embodiment.

The authorization service 120 may be connected to and/or in communication with various electronic data stores, such as a requestor data repository 130 and/or a client data repository 134. The requestor data repository 130 may include account records for a variety of different vendors that are each registered with the authorization service 120 to request authentications via the authorization service 120 and/or initiate purchases or other transactions via the authorization service 120. For example, according to some embodiments, a variety of third-party companies, organizations and/or individuals may register with the authorization service 120 prior to any given company, organization or individual sending transaction requests to the authorization service 120. Some examples of a vendor that may have associated data stored in requestor data repository 130 (and which may also be an owner or operator of the illustrative vendor computing device 104) may include a retail store, a money transfer service, a non-profit organization, a doctor's office, a government agency, a website operator, a computer application developer or distributor, and/or any other organization, company, or individual that desires to utilize the services of the authorization service 120 to authorize a transaction, verify a person's identity, or obtain other affiliated services provided by the authorization service 120 in a given embodiment. In other embodiments, the authorization service 120 may be configured to accept and process communications originating from systems, companies or organizations that are not associated with any previously registered account with the authorization service 120, in which case a requestor data repository 130 may not be present.

Data or information stored in association with each vendor account in requestor data repository 130 may include a requestor account identifier and a requestor code. The requestor code may be, for example, a series of numeric digits (such as “1033”) or may be an alphanumeric string (e.g., “CaHt9232”). In other embodiments, the requestor code may be a significantly longer series of bits or other data that may be stored as a file, such as a digital certificate or token. In some embodiments, the data stored in association with each vendor account in the requestor data repository 130 may include a variety of other information regarding an owner of the account and/or a vendor computing device 104 associated with the account. The additional information stored in the requestor data repository 130 in a given embodiment may depend on the type(s) of electronic transactions that the authorization service 120 is configured to authorize in the given embodiment. For example, if the requestor data repository 130 is configured to provide authorization for financial transactions, the requestor data repository 130 may store account balances. As another example, if the requestor data repository 130 is configured to provide authorization for the release of personal information associated with a user or client, the requestor data repository 130 may store information regarding the organization type that the account belongs to and/or an associated level of information access granted to the organization by the authorization service 120, by one or more clients, and/or by a third-party regulatory authority or other source.

Data or information stored in client data repository 134 in association with each client account may include a client account identifier, a shared code, and a private code. The shared code and private code may each be, but are not limited to, a series of numeric digits or an alphanumeric string. In some embodiments, the shared code and private code may each be considered to be a different personal identification number (or PIN code) associated with the client's account. The shared code stored for a given account would typically be different than the private code stored for the same account, and the authorization service 120 may enforce this difference as a requirement when establishing each code or accepting an initial or new code from a client, in some embodiments. The shared code may be considered “shared,” in some embodiments, in the sense that a given client may be required to provide his or her shared code to other individuals or computing systems (such as a vendor computing device 104) as part of initiating a communication. Accordingly, the shared code for a given client account may not be considered secure or private, at least with respect to the knowledge of a client's shared code by those vendor computing devices 102 or associated operators with whom the given client has interacted during communication. In contrast, the private code of a given client may be considered private in the sense that the client can initiate and verify communications without revealing his or her private code to any entity or system other than the authorization service 120.

As will be appreciated, other information may be stored in association with each client account in client data repository 134 in various embodiments, such as a mobile phone number, a device identifier (such as a MAC address, if applicable for a given device), information regarding the technical capabilities of the client's device (such as whether it supports encryption or other security protocols or standards), an account balance, a full name, personal information, data to potentially be released to vendor computing devices upon authentication by the authorization service 120, and/or other information.

In some embodiments, each of requestor data repository 130 and client data repository 134 may be local to authorization service 120, may be remote from the authorization service 120, and/or may be a network-based service itself. The requestor data repository 130 and client data repository 134 may be embodied in hard disk drives, solid state memories, any other type of non-transitory computer-readable storage medium, and/or a file, a database, a relational database, in-memory cache, and/or stored in any such non-transitory computer-readable medium accessible to the authorization service 120. The requestor data repository 130 and client data repository 134 may also be distributed or partitioned across multiple local and/or remote storage devices without departing from the spirit and scope of the present disclosure. In some embodiments, the data referred to herein as being stored in the requestor data repository 130 and the data referred to herein as being stored in the client data repository 134 may be stored in a single data store.

In the environment shown in FIG. 2, the vendor computing device 104 and the client device 110 each communicate with the authorization service 120 via the same or different communication network(s), depending on the environment. In some embodiments, the network 108 may be a personal area network, local area network, wide area network, cable network, satellite network, cellular telephone network, etc. or combination thereof. For example, the network 108 may be a publicly accessible network of linked networks, possibly operated by various distinct parties, such as the Internet. In some embodiments, the network 108 may be a private or semi-private network, such as a corporate intranet. The network 108 may include one or more wireless networks, such as a Global System for Mobile Communications (GSM) network, a Code Division Multiple Access (CDMA) network, a Long Term Evolution (LTE) network, or some other type of wireless network. The network 108 can use protocols and components for communicating via the Internet or any of the other aforementioned types of networks. Protocols and components for communicating via the Internet or any of the other aforementioned types of communication networks are well known to those skilled in the art and, thus, are not described in more detail herein. In some embodiments, the network 109 may be a Wi-Fi network, Bluetooth network, or a cellular telephone network capable of delivering SMS messages to feature phones or other mobile devices. In other embodiments, the network 109 may be any of the other network types mentioned above or similar, including but not limited to the Internet.

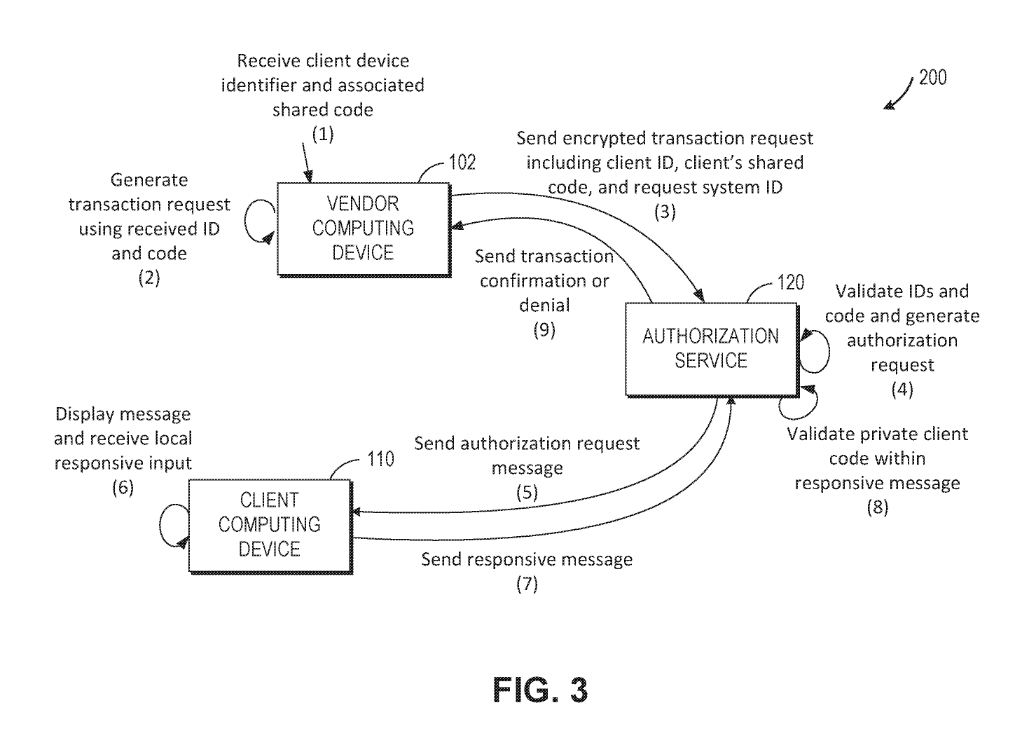

FIG. 3 is a block diagram illustrating the authorization service 120 authenticating a transaction request within the operating environment of FIG. 2. The illustrated flow 200 begins with the vendor computing device 104 receiving a client device identifier (or client account identifier, in other embodiments) and an associated shared code. The client device identifier and shared code may be provided to the vendor computing device 104 by a human operator of the transaction request system, using a keyboard, touchscreen or voice input. In some embodiments, a person who is a client of the authorization service 120 and who has previously established an account with the authorization service 120 may verbally provide his client identifier and shared code to an operator of the vendor computing device (such as a store clerk at a physical retail store, a doctor's office assistant, a teller at a bank or some other operator) as part of an in-person interaction. In other embodiments, some of the provided information (such as a client device identifier) may be communicated from a client computing device 110 to the vendor computing device 104 while the client's device is physically near the vendor computing device 104, such as using NFC, Bluetooth, an optical code (such as a barcode or Quick Response Code scanned by an optical reader), or RFID.

For example, a client may desire to initiate a transaction with the operator of the vendor computing device in order pay for goods or services, to establish the client's identity, to authorize release of electronic information regarding the client to the vendor computing device from the authorization service, or some other transaction purpose in accord with a given embodiment. In some embodiments, the client may provide an account identifier to the operator of the vendor computing device 104 for sending to the authorization service 120 along with the shared code. The client's account identifier may be a unique number, word, or string previously established between the client and the authorization service 120 to uniquely identify the client and/or the client's account with the authorization service 120.

Once the client identifier and shared code provided by the individual representing himself to be the given client are provided to or entered in the vendor computing device 104, the vendor computing device 104 generates a transaction request that includes the entered client identifier and shared code, along with other transaction request information. The other transaction request information may include a requestor identifier associated with the vendor computing device 104, and information regarding the requested transaction, such as a price and brief description of a good to be purchased. In some embodiments, the transaction request may be generated by a software application developed by the operator of the authorization service 120 that was previously provided to the vendor computing device (such as an application developed for a POS system, a tablet computer, a laptop or some other computing system used as the vendor computing device 104 in a given embodiment). In other embodiments, the transaction information may be entered via a secure webpage (such as a webpage that utilizes Transport Layer Security, Secure Sockets Layer, or other security technology) or other secure user interface provided by or generated by the authorization service 120 and sent to the vendor computing device 104 for display. Whether the transaction request is generated by an application associated with the authorization service 120, a webpage displayed within a browser program, or in another manner, the information of the request may be encrypted by the vendor computing device 104 and/or other associated hardware (such as a network router) using known methods prior to the request being communicated over a network, such as network 108. The encryption or other security steps for protecting the network communication of the client's shared code may prevent a nefarious party from electronically eavesdropping or intercepting network communications to learn of the client's shared code, thereby providing an account safeguard in the event that the nefarious party is able to subsequently intercept a second code of the client's account in a later unencrypted communication.

As illustrated in FIG. 3, the transaction request generated by the vendor computing device 104 is communicated in a secure manner (such as in an encrypted transmission and/or over a secure network) to the authorization service 120. In some embodiments, the information communicated within the encrypted transaction request may include a client identifier, a shared code provided by the purported client to the transaction request system, a service provider identifier that identifies the vendor computing device 104, and information regarding the nature of the transaction or other transaction details. In response to receiving the request, the authorization service 120 may decrypt the transaction request and validate the provided client identifier, the provided shared code, and the provided request system identifier by comparing the provided information to previously stored identifiers and associated codes in the requestor data repository 130 or client data repository 134, as appropriate.

If either of the provided identifiers or the provided shared code do not match the stored records, the authorization service 120 may send a transaction denial indication to the vendor computing device 104 (denial not illustrated in FIG. 3). If the authorization service 120 instead successfully validates the provided identifiers and shared code, the authorization service 120 generates an authorization request message and sends the message to the client device 110 over a network, such as a cellular network. For example, the message may include human-readable text information regarding the requested transaction (such as by identifying the requestor, a good to be purchased, an amount of money or credit to be transferred, and/or other information), and may be sent to the client computing device 110 associated with the provided client identifier in the client data repository 134.

As further illustrated in FIG. 3, the client device 110 may receive the authorization request message and may display the message on a display screen of the client device. The user of the client device 110 (who is most likely the client) may then enter a responsive message on the client device 110. For example, the authorization message may prompt the client to enter the client's private code in a responsive message if the client approves the transaction. In other embodiments, it may be assumed that the client knows that entering his private code in a responsive text message will approve the transaction (for example, the text content of the authorization message may not mention that a code is needed). If the client approves of the transaction (most likely because the client was the person that initiated the transaction at the vendor computing device 104), the client may enter a responsive text message that includes his private code (such as an alphanumeric string or numeric digits) as content of the message, and the client device may send the responsive message via a network, such as network 109 to the authorization service 120. If the client does not recognize the transaction (such as because the client was not the person that initiated the transaction request), the client may respond with message content that does not include the private code (such as a predetermined refusal string of “no,” in some embodiments) or may simply not respond. As will be appreciated, if the user of the client device 110 is not the actual client (such as because the client's device was stolen or cloned), the user will likely not know the client's private code and be unable to respond to the authorization message with the proper authorization.

If the authorization service 120 receives a responsive message from the client device 110, the authorization service 120 searches the content of the message for the client's private code (as retrieved by the authorization service 120 from the client data repository 134). In some embodiments, the authorization service 120 may apply one or more rules when determining whether the message provides sufficient authorization. For example, in one embodiment the private code may be required to be the only content of the message, while in other embodiments the authorization service 120 may allow the client to include a note, memo, or other content in the message for storing in a transaction data store in association with the transaction and/or for the authorization service 120 to provide to the vendor computing device 104 when confirming the transaction. If the authorization service 120 successfully validates the transaction based on the client's response, the authorization service 120 sends a transaction confirmation indication to the vendor computing device 104. The authorization service 120 may additionally perform other transaction steps upon validation according to the nature of the transaction (such as altering account balances associated with the requestor's account and the client account to reflect a transfer from the client's account to the requestor's account). If the authorization service 120 determines that the client has not successfully validated the transaction (such as because the client did not respond with the correct private code within a predetermined amount of time after the sending of the authorization request message), the authorization service 120 may send a transaction denial indication to the vendor computing device 104. For example, in one embodiment, the authorization service 120 may start a timer for a predetermined amount of time (such as one minute) upon sending the authorization message, and may be configured to automatically consider the transaction request to have failed if a validated responsive text message is not received back from the client device prior to expiration of the timer.

In some embodiments, the operator of the vendor computing device 104 may not have a relationship with the authorization service 120 or its operator prior to transmitting the transaction request. The authorization service 120 may process transaction requests from a previously unknown vendor by, for example, generating an account for the vendor, which may have an initial credit balance based on the amount of the transaction request. The authorization service 120 may further generate and provide a vendor identifier associated with the account, and may provide the vender identifier in its response to the vendor computing device 104. The vendor identifier may thus enable the previously unknown vendor to access the newly generated account. In further embodiments, the authorization service may determine a vendor account to associate with the request based on, for example, an IP address, MAC address, or other identifier associated with the vendor computing device 104, or may generate a vendor identifier based on characteristics of the vendor computing device 104.

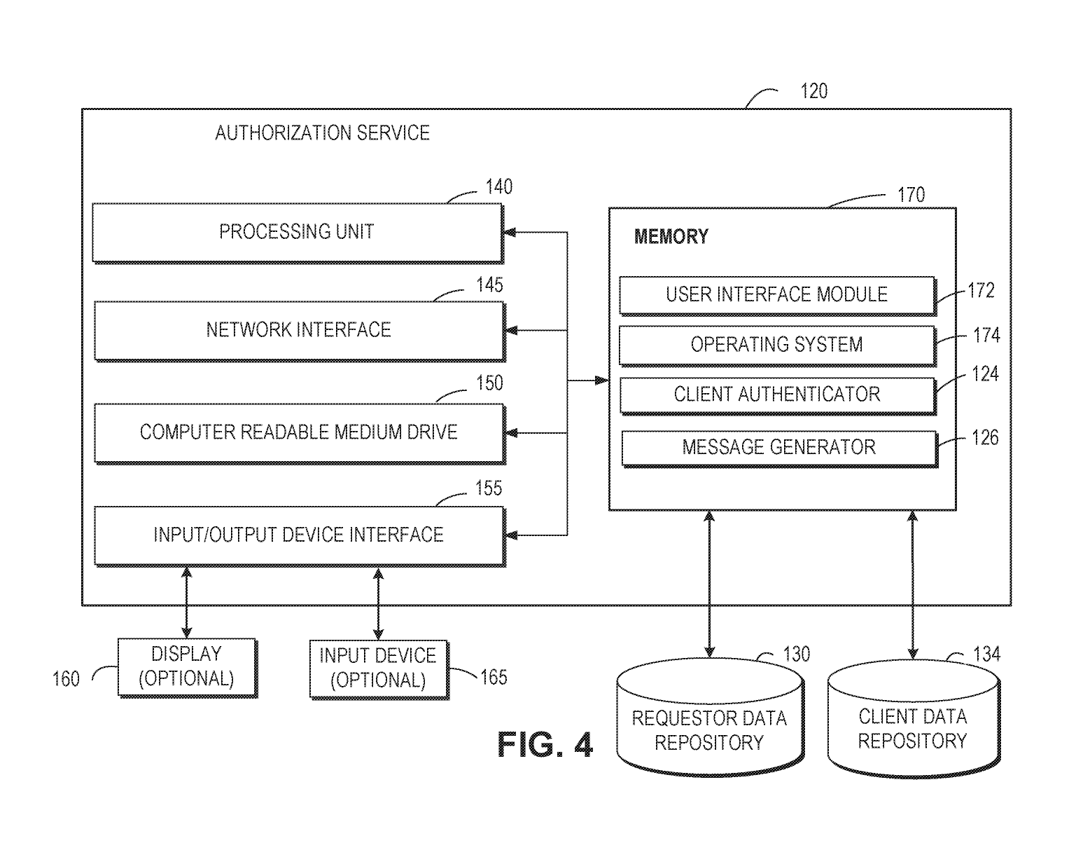

FIG. 4 depicts a general architecture of a computing system (referenced as authorization service 120) that may implement various aspect of the present disclosure, including communicating with both a vendor computing device and a client device in determining whether to authorize an electronic transaction originating from a vendor computing device or other remote system. The general architecture of the authorization service 120 depicted in FIG. 4 includes an arrangement of computer hardware and software components that may be used to implement aspects of the present disclosure. The authorization service 120 may include many more (or fewer) elements than those shown in FIG. 4. It is not necessary, however, that all of these generally conventional elements be shown in order to provide an enabling disclosure. As illustrated, the authorization service 120 includes a processing unit 140, a network interface 145, a computer readable medium drive 150, an input/output device interface 155, an optional display 160, and an optional input device 165, all of which may communicate with one another by way of a communication bus. The network interface 145 may provide connectivity to one or more networks or computing systems. In some embodiments, the network interface 145 may include cellular communications hardware, an Ethernet card, a modem, and/or WiFi communications hardware. Cellular communications hardware may include an antenna and other physical components such as a chip, SIM card(s), a radio transceiver, a modem and/or other hardware known in the art that is capable of sending and receiving information via a cellular network, such as a GSM network, LTE network or CDMA network. The processing unit 140 may thus receive information and instructions from other computing systems or services via a network, such as networks 108 and/or 109, and in some embodiments may interact with network interface 145 hardware to transmit and receive radio signals from a cellular network or other wireless network. The processing unit 140 may also communicate to and from memory 170 and further provide output information for an optional display 160 via the input/output device interface 155. The input/output device interface 155 may also accept input from the optional input device 165, such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or other input device known in the art.

The memory 170 may contain stored computer program instructions (which may be grouped as modules or components in some embodiments) that the processing unit 140 executes in order to implement one or more embodiments. The memory 170 generally includes RAM, ROM and/or other persistent, auxiliary or non-transitory computer readable media. The memory 170 may store an operating system 174 that provides computer program instructions for use by the processing unit 140 in the general administration and operation of the authorization service 120. The memory 170 may further include computer program instructions and other information for implementing aspects of the present disclosure. For example, in one embodiment, the memory 170 includes a user interface module 172 that generates user interfaces (and/or instructions therefor) for display upon a computing device, e.g., via a navigation interface such as a browser or application installed on the computing device. In addition, memory 170 may include or communicate with requestor data repository 130, client data repository 134 and/or one or more other data stores.

In addition to and/or in combination with the user interface module 172, the memory 170 may include a client authenticator 124 and a message generator 126 that may be executed by the processing unit 140. In one embodiment, the client authenticator 124 and message generator 126 individually or collectively implement various aspects of the present disclosure, e.g., validating client identifiers and codes, generating and sending authorization request messages, generating transaction confirmations and denials, etc., as described further below.

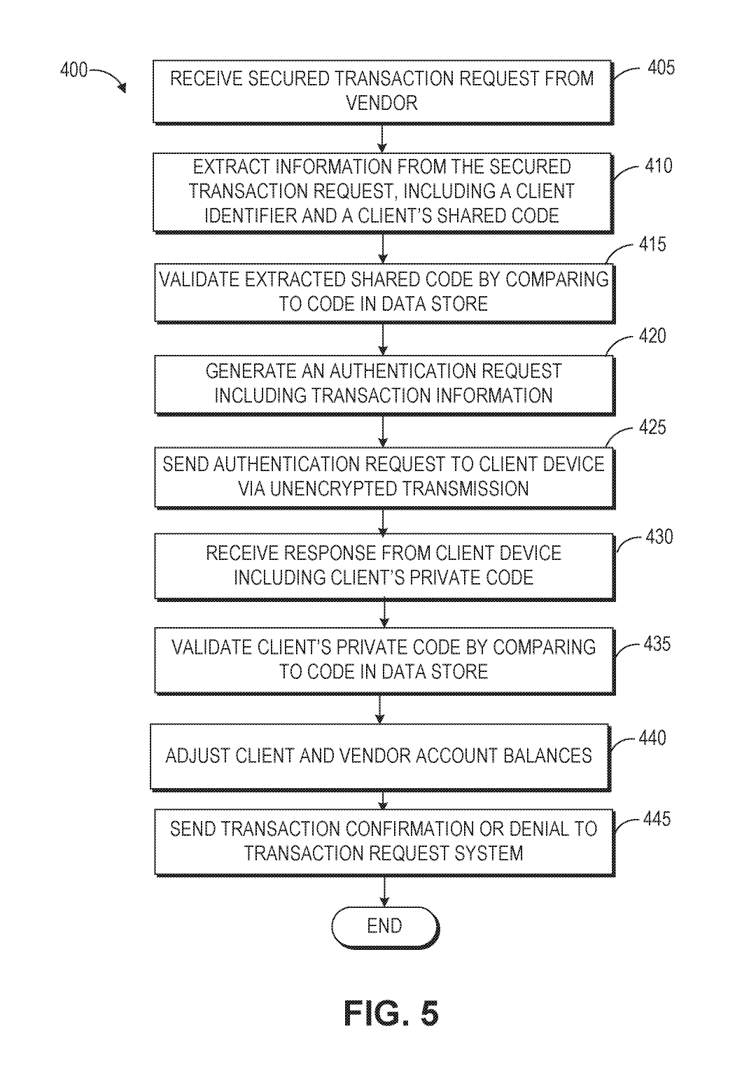

FIG. 5 is a flow diagram of an illustrative method 400 implemented by the authorization service 120 for authorizing an electronic transaction and/or authenticating the source of a transaction request. The illustrative method 400 is similar to that described above with respect to FIG. 3, although the flow diagram of FIG. 5 is from the perspective of the authorization service 120, such that each block of the flow diagram may be performed by the authorization service 120 (such as by one or more hardware processors that implement computer-executable instructions of the client authenticator 124 and/or message generator 126).

The illustrative method 400 begins at block 405, where the authorization service 120 receives a transaction request in an encrypted transmission or otherwise secure communication from a transaction request system, such as the vendor computing device 104. As discussed above, the transaction request may include a client identifier identifying one party to the requested transaction, a shared code purportedly associated with the account of the identified client, a requestor identifier identifying an owner or operator of the vendor computing device 104 (e.g., the second party to the requested transaction), as well as optional additional information regarding the requested transaction. At block 410, the client authenticator 124 may extract the various information elements from the encrypted transmission, such as by decrypting the transmitted data and extracting each data element (e.g., the client identifier, the client's code, etc.) from fields or other portions of the transmitted request information.

At block 415, the client authenticator 124 may validate the extracted shared code by comparing the extracted code to the client's shared code stored in the client data repository 134, as previously described above. If the shared code does not match, the transaction request may be denied and the illustrative method may end (not illustrated). If the shared code matches, the illustrative method proceeds to block 420, where the message generator 126 generates an authorization message for the client, as described above, and sends the message to the client device at block 425. As previously described, the message may be sent in an unencrypted form due to technical limitations of the client's device, yet the overall transaction protocol may remain relatively secure due to the other safeguards (such as the use of both a private and shared code that may each be sent via different networks between different systems).

At block 430, the client authenticator 124 may receive a responsive message from the client device, likely in an unencrypted form depending on the technical capabilities of the particular client device. As previously described with reference to FIG. 3, the client authenticator 124 may then validate the client response by searching the responsive message from the client device for the preset private code associated with the client's account, at block 435. At block 440, depending on the results of the validation block 435, the authorization service 120 may perform any transaction-specific actions. A transaction-specific action in a given embodiment may include, for example, debiting an account of the client, crediting an account of the requestor, releasing electronic information (such as personal information or otherwise confidential information regarding the client or the client's account), releasing an electronic document associated with the client's account (such as an electronic credential, medical records, a passport, financial records, etc.) and/or any other action that a client and/or transaction requestor may have requested and for which the authorization service 120 has been configured in a given embodiment. At block 445, the authorization service 120 may generate and send a transaction confirmation or denial indication to the transaction request system.

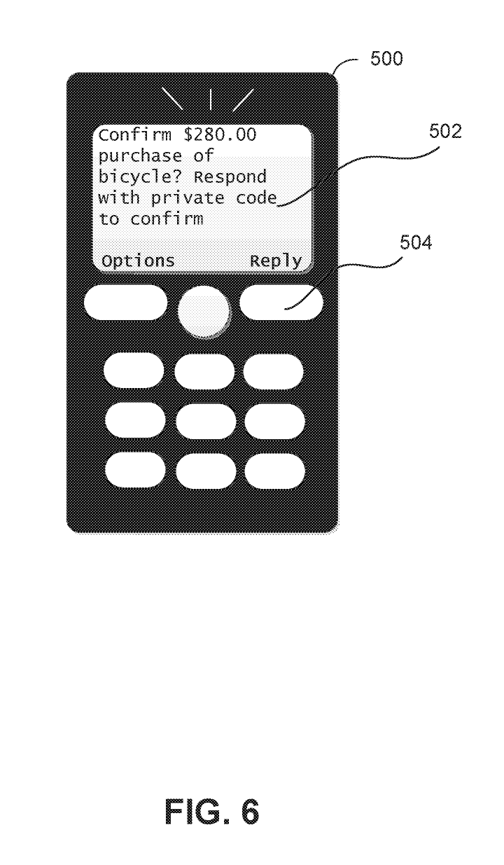

FIG. 6 depicts an example of a client authentication request. In the illustrated embodiment, the client authentication request has been sent as a text message 502 displayed on a mobile computing device 500, which may have been generated by an authorization service 120 and sent to the mobile computing device 500 as an SMS message via a cellular network. The text content of illustrative message 502 reads “Confirm $280.00 purchase of bicycle? Respond with private code to confirm.” Those of skill in the art will appreciate that the wording of information and extent of transaction information included in the message may vary widely depending on the transaction purpose and the embodiment. For example, the authorization service 120 may provide or retrieve a template for the client authentication request (e.g., “Confirm $______ purchase of ______? Respond with private code to confirm”), and may populate the template with, for example, a transaction amount and product name that are supplied by the vendor that generates the transaction request. As another example, in a transaction request for the electronic release of information, the client authentication request may include an indication of the requested information (e.g., “Release your Sierra Bicycle Club membership details to Stan's Bike Shop?”). In the illustrated example, the user of device 500 may press a physical button 504 on the device 500 in order to begin composing a responsive text message, in which the user may enter his private code using numeric or alphanumeric buttons. In other embodiments, various different methods and mechanisms for entering responsive messages may be utilized depending on the specific hardware and software associated with the user's device. For example, the user may provide input via a touchscreen, external keyboard, gestures, voice, or in any other manner supported by the given device. In further embodiments not illustrated in FIG. 6, a client authentication request may be generated and sent as, for example, a push message, an email message, a voice prompt from an IVR system, or other forms of communication. For example, an automated phone call may be made from the authorization service to the mobile device 500 requesting that the user verbally state his private code or enter his private code using a keypad or touchscreen on the device.

In some embodiments, various additional security measures may be implemented by the authorization service beyond those described above. For example, the authorization service 120 may maintain in client data repository 134, a third code for each client, in addition to the private code and the shared code described above. In some embodiments, the client may be required to provide the third code to the authorization service in order to make changes to his account, such as to change either the given client's private code or the shared code.

According to some embodiments, the authorization service may maintain a record of the technical capabilities of each client's device(s) in client data repository (such as whether the device has Internet access, supports encryption, may receive push notifications, has an application associated with the authorization service 120 installed on the device, etc.) and may send transaction authorization messages and other communications to a given client device in a different form depending on the capabilities of the device. For example, if the authorization service has determined that a given client has a smartphone and/or appropriate application on his device, the authorization service 120 may send messages to that device via an encrypted message, a push notification delivered via a proprietary application on the device, and/or in some other manner.

In some embodiments in which a client's mobile phone or other computing device includes an executable application associated with the authorization service, such an application may prompt the client to enter a security code within a user interface generated by the application upon receiving a push notification from the authorization service that requests transaction authorization. In some such embodiments, the application may be configured to cause the client computing device to send a different code or authentication sequence to the authorization service than what the user enters. For example, while a client may consider his private code to be the digits “8798” and may enter those numbers via a user interface, the client computing device may locally check that this code is correct based on locally stored information, and in response send a different, more complex private validation code to the authorization service. Accordingly, in some embodiments, instead of a client entering the same private code that is stored by the authorization service in association with the client's account, the client's computing device may be configured to prompt the client for some different verification input that, when successfully validated locally, causes the client computing device to send the correct private code to the authorization service.

The authorization service may, in some embodiments, process deposits and credits to a client account or a vendor account using systems and methods described herein. For example, the authorization service may receive a request from a financial institution or agent to deposit funds into a client account. The client may provide funds and a shared code to the financial institution, which may in turn transmit a deposit amount and the shared code to the authorization service. The funds may be deposited into the client's account immediately, or may be held in a global account until the deposit is confirmed. For deposits, the authorization service may omit sending a client authentication request, or in some embodiments the service may send the client authentication request to allow the client to confirm that funds are being deposited into the correct client account. As further examples, the client may deposit funds by sending an image of a paper check or other instrument to the authorization service, by arranging direct deposit of a paycheck or other annuity, by using a bank card, or by transferring funds from another account into the client's account.

In some embodiments, the authorization service may process withdrawals from a client account or a vendor account. For example, a bank, agent, or other institution may transmit a withdrawal amount and a shared code to the authorization service, which may process the withdrawal request as described above and indicate that the bank should provide the funds to the client. The client may similarly request a transfer of funds from the client's account to another account. The authorization service may, in some embodiments, associate fees with deposits and withdrawals, which may be separately debited from the client's account or may reduce the amount of a deposit or withdrawal. Still further, in some embodiments, the authorization service may provide currency exchange services, may associate multiple balances in various currencies with a particular client account, and/or may process requests to convert funds from one currency to another.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. An authentication system for securely authorizing an electronic transaction, the system comprising:
an electronic data store configured to store information regarding a plurality of electronic accounts, wherein information for a first account of the plurality of electronic accounts comprises at least a first client identifier, a client account balance, a shared authentication code, and a private authentication code;
a physical processor in communication with the electronic data store and configured with processor-executable instructions to perform operations comprising at least:
receiving, within a secured transmission from a vendor computing device, a transaction request, the transaction request comprising a client identifier, a transaction amount, and a first authentication code;
determining that the client identifier in the transaction request matches the first client identifier associated with the first account in the electronic data store;
validating the first authentication code, wherein validating the first authentication code comprises determining that the first authentication code matches the shared authentication code associated with the first account in the electronic data store;
in response to successfully validating the first authentication code, generating an authorization request, the authorization request comprising:
information identifying the transaction request; and
a request to provide the private authentication code;
identifying, based at least in part on the first client identifier, a client computing device associated with the first client identifier;
transmitting the authorization request to the client computing device;
receiving, from the client computing device, a response to the authorization request, the response including at least a second authentication code, wherein the response is received within an unsecured transmission;
validating the second authentication code, wherein validating the second authentication code comprises determining that the second authentication code matches the private authentication code in the electronic data store;
debiting the client account balance by at least the transaction amount; and
transmitting, to the vendor computing device, a response indicating approval of the transaction request.

2. The system of claim 1, wherein the secured transmission is secured using at least one of encryption, a secure network protocol, or a private network.

3. The system of claim 1, wherein the unsecured transmission is transmitted via Wi-Fi, Bluetooth, radio frequency ID, near field communications, interactive voice response, short message service, or public Internet.

4. The system of claim 1, wherein transmitting the authorization request to the client computing device comprises transmitting audio via an interactive voice response system.

5. The system of claim 1, wherein information stored in the electronic data store for a second account of the plurality of electronic accounts comprises at least a first vendor identifier and a vendor account balance.

6. The system of claim 5, wherein the transaction request further comprises a vendor identifier, and wherein the physical processor is further configured with processor-executable instructions to perform operations comprising:
determining that the vendor identifier in the transaction request corresponds to the first vendor identifier associated with the second account in the electronic data store; and
crediting the vendor account balance by the transaction amount.

7. The system of claim 1, wherein the transaction request does not comprise any vendor identifier, and wherein the physical processor is further configured with processor-executable instructions to perform operations comprising:
generating a first vendor identifier corresponding to the transaction request;
generating a vendor account balance corresponding to the transaction amount;
storing information for a second account in the electronic data store, the information for the second account comprising the first vendor identifier and the vendor account balance,
wherein the response indicating approval of the transaction request includes at least the first vendor identifier.

8. The system of claim 1, wherein the first client identifier comprises at least one of a MAC address, a telephone number, or a network address.

9. The system of claim 1, wherein the electronic data store is further configured to store information regarding previous transaction requests associated with individual electronic accounts, and wherein the operations further comprise:
receiving, from the vendor computing device, a transaction history request comprising a device identifier;
determining that the device identifier in the transaction history request corresponds to the first client identifier associated with the first account; and
transmitting, to the vendor computing device, a response to the transaction history request, the response including at least information regarding previous transaction requests associated with the first account.

10. A computer-implemented method comprising:
as implemented by a computer system executing specific computer-executable instructions,
receiving a transaction request from a vendor computing device, the transaction request comprising a client identifier, a transaction amount, and a first authentication code, wherein the transaction request is received within a secured transmission;
obtaining authentication information regarding a plurality of electronic accounts, wherein the authentication information associates a first account of the plurality of electronic accounts with a first client identifier, a shared code, and a private code;
determining that the client identifier in the transaction request corresponds to the first client identifier in the authentication information;
determining that the first authentication code in the transaction request corresponds to the shared code associated with the first account;
identifying, based at least in part on the authentication information, a client computing device associated with the first client identifier;
transmitting an authorization request to the client computing device, the authorization request comprising information regarding the transaction request;
receiving, from the client computing device, a response to the authorization request, the response including at least a second authentication code;
determining that the second authentication code corresponds to the private code associated with the first account; and
in response to determining that the second authentication code corresponds to the private code associated with the first account, processing the transaction request.

11. The computer-implemented method of claim 10, wherein processing the transaction request comprises:
obtaining a client account balance associated with the first account;
obtaining a vendor account balance associated with an operator of the vendor computing device;
debiting the client account balance by at least the transaction amount;
crediting the vendor account balance by the transaction amount; and
transmitting, to the vendor computing device, a response to the transaction request, wherein the response indicates approval of the transaction request.

12. The computer-implemented method of claim 10 further comprising determining that the second authentication code was received within a predetermined time interval of transmitting the client authentication request.

13. The computer-implemented method of claim 10 further comprising:
receiving, within a second secured transmission from the vendor computing device, a second transaction request comprising the client identifier and a third authentication code;
determining that the third authentication code corresponds to the shared code associated with the first account; and
transmitting a second authorization request to the client computing device, the second authorization request identifying the second network service request.

14. The computer-implemented method of claim 13 further comprising:
receiving, from the client computing device, a second response to the second authorization request, the second response including at least a fourth authentication code;
determining that the fourth authentication code does not correspond to the private code associated with the first account; and
transmitting, to the vendor computing device, a response to the second transaction request, wherein the response indicates denial of the second transaction request.

15. The computer-implemented method of claim 13 further comprising:
receiving, from the client computing device, a second response to the second authorization request;
determining that the second response does not include an authentication code; and
transmitting, to the vendor computing device, a response to the second transaction request, wherein the response indicates denial of the second transaction request.

16. The computer-implemented method of claim 13 further comprising:
determining that a second response has not been received from the client computing device within a predetermined time interval of transmitting the second authorization request; and
transmitting, to the vendor computing device, a response to the second transaction request, wherein the response indicates denial of the second transaction request.

17. The computer-implemented method of claim 10, wherein the response to the authorization request comprises a text message, and wherein determining that the second authentication code corresponds to the private code associated with the first account comprises determining that the text message contains the private code.

18. A computing system comprising:
an electronic data store configured to store authentication information regarding a plurality of electronic accounts, wherein authentication information for a first account of the plurality of electronic accounts comprises at least a first client identifier, a shared code, and a private code;
a physical processor in communication with the electronic data store and configured with processor-executable instructions to perform operations comprising at least:
receiving, within a secured transmission from a vendor computing device, a network service request comprising a client identifier and a first authentication code;
determining that the client identifier in the network service request corresponds to the first client identifier associated with the first account in the electronic data store;
determining that the first authentication code corresponds to the shared code associated with the first account in the electronic data store;
generating an authorization request, the authorization request comprising information identifying the network service request;
identifying, based at least in part on the first client identifier, a client computing device associated with the first client identifier;
transmitting the client authentication request to the client computing device;
receiving, from the client computing device, a response to the authorization request, the response including at least a second authentication code;
determining that the second authentication code corresponds to the private code in the electronic data store; and
based on determining that the second authentication code corresponds to the private code, processing the network service request.

19. The computing system of claim 18, wherein the electronic data store is further configured to store account information regarding the plurality of electronic accounts, and wherein account information for the first account comprises at least an account balance.

20. The computing system of claim 19, wherein the network service request further comprises a transaction amount, and wherein processing the network service request comprises:
determining that the account balance is greater than the transaction amount;
in response to the determination that the account balance is greater than the transaction amount:
debiting the account balance by at least the transaction amount;
crediting a vendor account balance by the transaction amount, wherein the vendor account is associated with an operator of the vendor computing device; and
transmitting a confirmation message to the vendor computing device.

21. The computing system of claim 18, wherein processing the network service request comprises:
generating a response to the network service request, wherein the response indicates that the network service request should be fulfilled; and
transmitting the response to the vendor computing device, wherein transmitting the response causes the vendor computing device to debit an account balance associated with the first account.

22. The computing system of claim 18, wherein transmitting the client authentication request to the client computing device comprises sending a text message in an unencrypted form using a Short Message Service (SMS) communications protocol.

23. The computing system of claim 18, wherein transmitting the client authentication request to the client computing device comprises sending a push notification that causes an application executed by the client computing device to present for display the information identifying the network service request.
